(19) United States
(12) Patent Application Publication
(10) Pub. No.: US 2024/0205504 A1
(43) Pub. Date: Jun. 20, 2024

(54) Method for Notifying Programmes of Interest to a User of a Media Decoder

(71) Applicant: SAGEMCOM BROADBAND SAS, Bois-Columbes (FR)

(72) Inventor: Indiveri Piero, Bois-Colombes (FR)

(21) Appl. No.: 18/537,023

(22) Filed: Dec. 12, 2023

(30) Foreign Application Priority Data
Dec. 14, 2022 (FR) 2213365

(51) Int. Cl. H04N 21/472

(52) U.S. Cl. CPC H04N 21/47214

(57) ABSTRACT

A method including the following steps implemented by a media decoder, such as a digital television decoder: identifying a future programme playable via the decoder, constituting a programme of interest for a user of the decoder; making a comparison between a time until broadcast of the programme of interest and a predefined threshold; commanding the emission of an alarm signal perceptible by a person, provided that the time until broadcast is less than the predefined threshold.

### TECHNICAL FIELD

The present disclosure relates to a media decoder, such as a digital television decoder, and a method implemented by said decoder.

### BACKGROUND

Media decoders capable of recording programmes broadcast at a fixed time, on request of the user, are known. The user schedules in advance the recording of a programme of interest to him using an appropriate user command. The user can then play the recorded program at a later time.

However, the user may forget to schedule such a recording.

Furthermore, some programmes lose their interest when they are played on a delayed basis. This is the case for programmes broadcasting a live event, for example a sporting event such as a football match. If the user does not see such a programme at the time of broadcasting of the event, then third parties may disclose certain aspects of the event to the user (for example a match result).

### SUMMARY

One aim of the disclosure is to overcome the problems mentioned above.

This aim is achieved, according to a first aspect, by a method comprising the following steps implemented by a media decoder, such as a digital television decoder: identifying a future programme playable via the decoder constituting a programme of interest for a user of the decoder; comparing a time until broadcast of the programme of interest and a predefined threshold; commanding the transmission of an alarm signal, perceptible by a person, provided that the time until broadcast is less than the predefined threshold.

The method according to the first aspect can further comprise the following optional features.

Preferably, the alarm is emitted provided that a person in the vicinity of the decoder has been detected by a sensor of the decoder.

Preferably, the alarm is emitted provided that the detected person is recognised by the decoder as a user of the decoder having been previously enrolled.

Preferably, the alarm is emitted provided that the detected person is recognised by the decoder as the user of the decoder for which the programme is of interest.

Preferably, the alarm signal is emitted by the decoder when the decoder is in standby mode.

Preferably, the alarm signal is an audible signal.

Preferably, the alarm signal is emitted by a piece of external equipment on a command from the decoder when the decoder is in wake-up mode.

Preferably, the alarm signal is a visual signal.

Preferably, the alarm signal comprises a message indicating the programme of interest.

Preferably, the method also comprises a command for recording the programme of interest, the recording command being implemented provided no user action on the decoder has been detected in a predefined period starting from the transmission of the alarm signal.

Preferably, the identification is triggered when at least one of the following events occurs: a sensor of the decoder detects that a person is in the vicinity of the decoder, the decoder receives a list of future programmes playable via the decoder, a predefined period since a preceding implementation of the comparison has elapsed.

Preferably, the future programme consists of a programme of interest for the user of the decoder only if the following conditions are fulfilled: N past programmes having an identifier in common with the future programme have been played via the decoder, preferably while the user of the decoder was in the vicinity of the decoder, and N is greater than or equal to a predefined threshold. These conditions are cumulative.

According to a second aspect, a computer program product is proposed, comprising program code instructions for commanding the execution of method steps according to the first aspect, when this programme is executed by a media decoder.

According to a third aspect, a computer-readable memory is proposed, storing instructions executable by the computer in order to control the execution of the steps of the method according to the first aspect.

According to a fourth aspect, a media decoder is proposed, such as a digital television decoder, comprising: a user interface; at least one processor configured for: identifying a future programme playable via the decoder and constituting a programme of interest for a user of the decoder, comparing a time until broadcast of the programme of interest and a predefined threshold, and commanding the emission, by the user interface, of an alarm signal perceptible by a person, provided that the time until broadcast is less than the predefined threshold.

The decoder according to the fourth aspect can also comprise the following optional features.

The decoder according to the fourth aspect can comprise a sensor, the sensor comprising, for example, a microphone and/or a camera, and wherein the alarm is emitted provided that a person in the vicinity of the decoder has been detected by the sensor.

Preferably, the decoder according to the fourth aspect comprises a module for recognising persons, and wherein the alarm is emitted provided that a person detected by the sensor is recognised by the recognition module as a previously enrolled user of the decoder, or the user of the decoder for which the programme of interest has been identified.

### BRIEF DESCRIPTION OF THE DRAWINGS

Other features, aims and advantages of the disclosure will emerge from the following description, which is given purely by way of illustration and not being limiting and which should be read with reference to the attached drawings, in which:

FIG. 1 schematically illustrates a media decoder according to an embodiment, as well as other equipment.

FIG. 2 is a block diagram of steps of a first method implemented by a media decoder, according to an embodiment.

FIGS. 3 and 4 are two block diagrams of steps of a second method implemented by a media decoder, according to an embodiment.

In all the figures, similar elements have identical reference signs.

### DETAILED DESCRIPTION

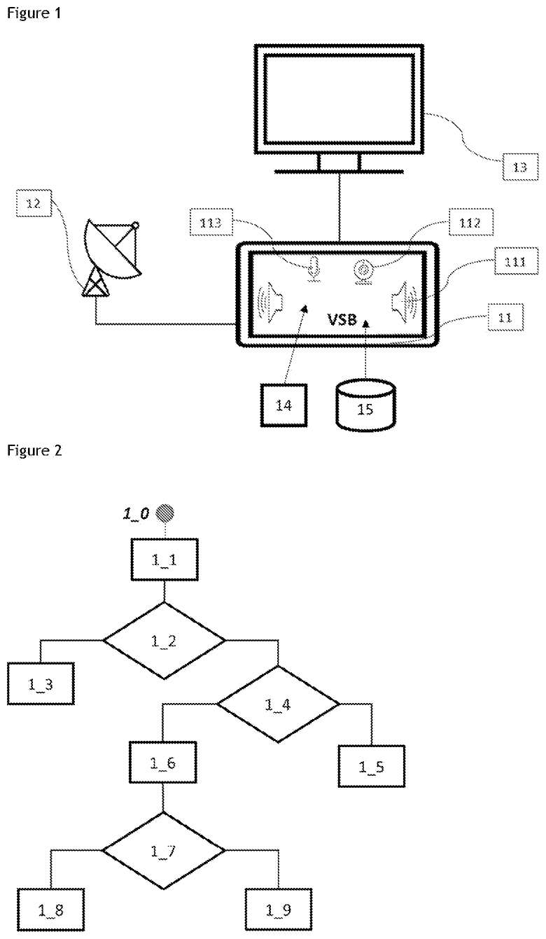

With reference to FIG. 1, a media decoder 11 according to an embodiment is a digital television decoder comprising an input 12, at least one output, a user interface, a data processing unit 14 and a memory 15.

The input 12 is suitable for receiving a stream of input data, for example a television stream. The stream of input data comprises programmes that are able to be decoded by the decoder 11, as well as metadata relating to the programmes. The programmes contain media of any type, for example audio data and/or video data. Metadata provide information on the programmes, and are known from the prior art.

The input 12 may be suitable for receiving the stream of input data from any network: a terrestrial digital television network (DTT), a cable television network, the Internet (in this case the input 12 is referred to as an IP interface).

Each output is suitable for transmitting output data, resulting from the input data, to a piece of external equipment 13 suitable for restoring these output data to a user. The piece of external equipment 13 comprises a display screen or a loudspeaker or both. The piece of external equipment 13 is, for example, a television or a speaker. Each output may comprise an output port able to be connected to the piece of external equipment via a cable, such as an HDMI cable. The decoder may comprise a plurality of outputs. For example, the decoder 11 comprises at least one audio/video output intended to communicate with a television and at least one audio output intended to communicate with a speaker.

The user interface is configured to interact with a user of the decoder 11. In particular, the user interface is configured to receive user commands and transmit them to the processing unit 14. For this purpose, the user interface may comprise a receiver capable of communicating with a remote control and/or a touch interface (physical buttons, touch sensitive interface, etc.).

In addition, the user interface of the decoder 11 is furthermore configured to emit signals perceptible by a user. For this purpose, the user interface comprises a speaker 111 capable of emitting audible signals. Alternatively, or in addition, the user interface is capable of emitting visual signals. For this purpose, the user interface may comprise an indicator light and/or a display screen.

The data processing unit 14 is configured to generate output data from a stream of input data received via the input interface, and to command the emitting of output data via the output. This processing, known from the prior art, may involve extraction, decoding and/or conversion of data formats; it is known from the prior art. The output data typically comprise video data able to be displayed by the display screen and/or audio data able to be played by the speaker of the piece of external equipment 13.

The processing unit 14 is furthermore capable of commanding the emission of signals that are perceptible by a user. It should be noted that the processing unit 14 can also command an emission of signals produced by the output interface of the decoder 11, or even command the emission of signals by the piece of external equipment 13, by communicating with the latter via the output.

In particular, the processing unit 14 is configured to control the displaying, by the display screen of the piece of external equipment 13, of a graphic interface. For this purpose the processing unit 14 can ensure that the graphic interface is displayed by the piece of external equipment 13 superimposed with the video data from the input data stream. In a manner known per se, the graphic interface serves to present to a user, in an organised manner, the contents of the functionalities offered by the decoder 11. Typically, this graphic interface can comprise an electronic programme guide (EPG).

The processing unit 14 comprises one or more processors suitable for executing one or more computer programmes. The, or each, processor may have any type of structure: programmable circuit (FPGA or DSP) or non-programmable circuit (ASIC for example), controller, microcontroller, system on a chip, etc.

The memory 15 stores the coded instructions of the one or more above-mentioned programmes. These code instructions are typically stored in a non-volatile memory 15 (ROM or Flash, for example). Furthermore, the memory 15 is able to store data processed or generated by the or each processor, during the execution of these programmes. These data can be stored in a volatile memory 15 (RAM, for example) or in the above-mentioned non-volatile memory 15. The memory 15 is able, in particular, to store a database, the contents of which will be discussed below.

Optionally but very advantageously, the decoder 11 comprises a sensor of human presence in the vicinity of the decoder 11. The sensor in question can comprise a camera 112 and/or a microphone 113.

The human presence sensor preferably comprises a module for recognising persons. The person recognition module is configured for analysing a signal acquired by the sensor, so as to determine whether a person is in the vicinity of the decoder 11. The person recognition module is capable of enrolling users, in other words learning to recognise users, with a view to subsequently verifying whether the enrolled users are present in the vicinity of the decoder 11. Thus, the recognition module may be capable of determining whether or not a person in the vicinity of the decoder 11 is a previously enrolled user, and may also be capable of making the distinction between different enrolled users. The recognition module can use a neural network in order to implement this processing.

When the presence sensor comprises a camera 112, the recognition module is configured to implement facial recognition on the basis of images supplied by the camera 112. Deepface is an example of a facial recognition program that can be used in the decoder 11.

When the presence sensor comprises a microphone 113, the recognition module is configured to implement audible recognition on the basis of an audio signal acquired by the microphone 113. This audible recognition can, for example, rely on a classification algorithm, for example that described in document CN101751920A.

In general, the decoder 11 can operate in several modes, in particular standby mode and wake-up mode:
In standby mode, the decoder 11 does not emit data on the outputs. The decoder 11 consumes less energy in standby mode than in wake-up mode.
In wake-up mode, the decoder 11 emits data on at least one output.

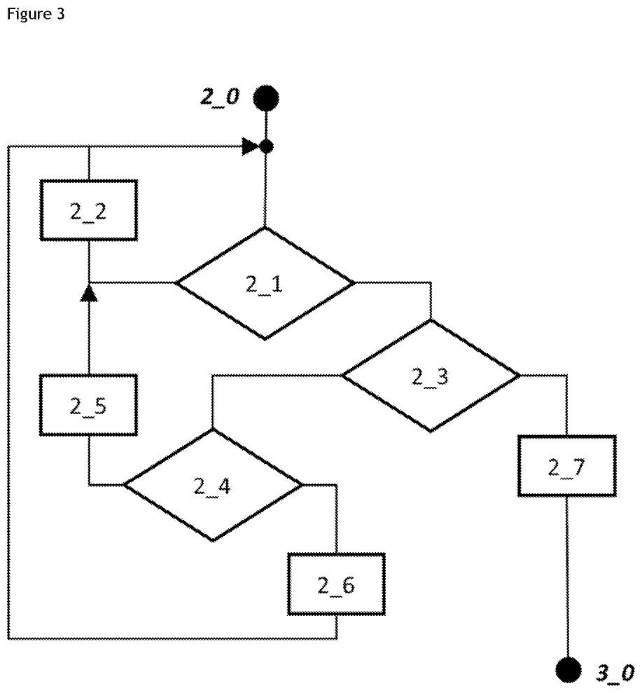

With reference to FIG. 2, a method 1_0 for marking programmes, implemented by the decoder 11, comprises the following steps.

It is assumed that the decoder 11 is in use. A user of the decoder 11 has interacted with the user interface, so that a programme is played to said user via the decoder 11. This implies that the processing unit 14 generates output data from input data received by the input, and ensures that audio and/or video data of the programme are restored to a user, either directly by the user interface of the decoder 11 or by means of one or more pieces of external equipment 13. In the case of a programme comprising video data, the programme played via the decoder is, in reality, a programme that the user views on the display screen of the piece of external equipment 13.

In a step 11, the processing unit 14 recovers an identifier “prog_id” of the programme that is being played via the decoder 11. This step 1_1 is, for example, triggered on the expiry of a predefined period starting from the moment when the programme began to be played via the decoder 11. This is advantageous in order to avoid the steps of the method being triggered for programmes channel-hopped by the user.

In a step 1_2, the processing unit 14 accesses the database stored in the memory 15, and checks whether this database references a programme for which the identifier corresponds to the identifier “prog_id” recovered during substep 11. If no, then the method moves to step 13. If yes, the method moves to step 1_4.

In step 1_3, the processing unit 14 adds the identifier “prog_id” recovered in the database.

In step 1_4, the processing unit 14 checks whether the programme found in the database (having “prog_id” as identifier) is already marked as being of interest for a user of the decoder 11. If yes, the method moves to step 15. If no, the method moves to step 1_6.

In step 1_5, the processing unit 14 increments number N. The number N indicates how many programmes having “prog_id” as identifier have been played via the decoder 11.

The processing unit 14 then returns to step 1_1.

In substep 16, the processing unit 14 increments the number N, and moves to step 1_7.

In step 1_7, the processing unit 14 checks whether the number N is greater than or equal to a predefined threshold S. If yes, then the method moves to step 1_9. If no, the method moves to step 1_8.

In step 1_9, the processing unit 14 marks the programme in the database, so as to indicate that the programme is of interest for a user of the decoder 11. The marking may consist in associating, in the database, the identifier “prog_id” with a datum indicating that the programme is of interest for the user. Whatever the concrete form of the marking, the processing unit 14 is capable of distinguishing between a programme marked as of interest and an unmarked programme, based on the content of the stored database.

In substep 18, the processing unit 14 marks the programme so as to indicate that the programme is not of interest for a user of the decoder 11. Step 18 is optional, because it may be envisaged that the processing unit 14 does not perform any particular marking when N<S. In this case, the processing unit 14 considers that an unmarked programme is not a programme of interest for a user of the decoder 11. The method then returns to step 1_1.

In a preferred embodiment, the processing unit 14 implements the preceding steps for various users of the decoder 11. In this case, the human presence sensor is used to detect that a previously enrolled user is in the vicinity of the decoder 11, while the programme is played. The steps described above are then implemented for this detected user, while updating a database belonging to this enrolled user. Hence, different databases for different users are stored in the memory 15. In this way, the decoder 11 can determine programmes of interest for different users, possibly having different tastes.

The above-mentioned marking method functions automatically. It should however be noted that a user of the decoder 11 can, alternatively or in addition, command the marking of a programme as being of interest for said user, via the user interface.

Alternatively, the decoder can use any other method from the prior art that can identify programmes of interest for the user. For example, rather than identifying programmes by their identifier “prog_id,” the decoder can use the combination of a piece of information on the programme type (“TV detective film”, “romantic series”) and time slot (“Tuesday evening”), or the combination of a television channel and time slot.

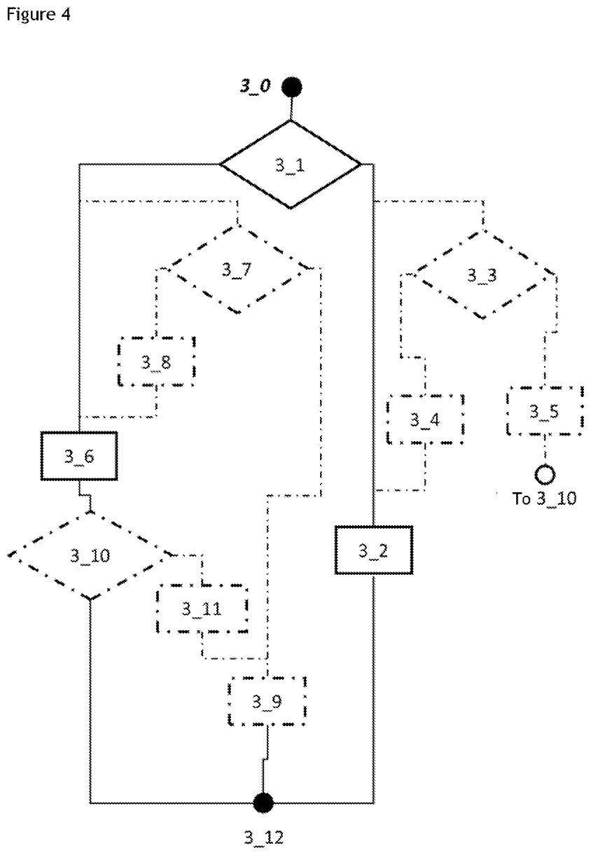

With reference to FIGS. 3 and 4, a second method implemented by the decoder 11 comprises the following steps. This second method is implemented after implementing the marking method.

The second method comprises two phases: a phase 2_0 of searching for at least one future programme of interest for a user of the decoder 11, and an alert phase 30.

The search phase can be triggered in different ways.

According to a first embodiment, the search phase is triggered periodically, for example every 5 minutes. Thus, the search phase is implemented when a predefined period of time starting from a preceding implementation of the search phase has elapsed (this period of time corresponds to the chosen period).

According to a second embodiment, the search phase is triggered when an update of the list of future programmes is received by the decoder 11 via its input. This update can, in particular, be scheduled for a fixed time (for example, every day at midnight), or be carried out on the fly when the decoder is woken up.

According to a third embodiment, the search phase is triggered when the decoder 11 detects that a person is in the vicinity of the decoder 11, or else a user of the decoder 11, or else the user for which the programme of interest as been identified, by means of the human presence sensor discussed above. It is seen here that the detector can operate at two different levels of precision: the decoder 11 can be satisfied with any human presence in order to trigger the search phase. Alternatively, the decoder 11 can require that a person detected in the vicinity corresponds to a previously enrolled user of the decoder 11 in order to trigger the search phase: in this case, the human recognition module is used.

At least one of these conditions may be used by the decoder 11, for example all three. These conditions are sufficient conditions, in the sense where it is sufficient that one of them is satisfied in order to trigger the search phase.

An embodiment of the search phase will now be described in relation to FIG. 3.

It is assumed that the decoder 11 has received, via the input, metadata comprising a list of future programmes, in other words a list indicating programmes for which the media data (audio and/or video) will be broadcast in the future by a content provider, and which will then be able to be received by the input and be played via the decoder 11.

The metadata comprise, for each programme of the list, a programme name and a time of broadcast of the programme. The time of broadcast of the programme is a time which indicates the start of the broadcast of the media data of the programme by the above-mentioned content provider. The metadata may, in this case, comprise supplementary data, for example a description of the programme and other information relating to the programme.

In a step 2_1, the processing unit 14 checks whether the list of future programmes comprises a programme having an identifier in common with a programme marked as being of interest for a user of the decoder 11 in the corresponding database.

If the processing unit 14 identifies, in the list, a future programme fulfilling these criteria, then this future programme is considered as being of interest, and the method moves to step 2_3. If no, the method moves to step 2_2.

In step 2_2, the unit waits for a period t1 before returning to step 2_1.

In step 2_3, the processing unit 14 calculates the time until broadcast of the identified programme, in other words the duration between a current time and the time of broadcast of the identified programme. The unit then compares this time until broadcast of the identified programme and a predefined threshold t2. If the time until broadcast of the identified programme is greater than the threshold t2, then the method moves to step 2_4. If the time until broadcast of the identified programme is less than or equal to the threshold t2, the method implements the alert phase (in FIG. 3, this transition is indicated by block 2_7, and the circle 3.0 indicates the start of the alert phase).

In step 2_4, the processing unit 14 checks whether other programmes remain to be examined in the list of future programmes. If yes (case marked by block 2_6 in FIG. 3), the method moves to step 2_1 in order to examine the future programmes remaining in the list. If no (case marked by block 2_5 in FIG. 3), the decoder 11 moves to step 2_2.

With reference to FIG. 4, the alert phase 30 comprises the following steps.

In a step 3_1, the processing unit 14 checks whether the decoder 11 is in standby mode or in wake-up mode. If the decoder 11 is in wake-up mode, the method moves to step 3_2. If the decoder 11 is in standby mode, the method moves to step 3_6.

In step 3_2, the processing unit 14 commands the emission of an alarm. The alarm is a visual alarm emitted by the piece of external equipment 13 on the request of the decoder 11. For this, the processing unit 14 commands the transmission on the output of data representing a pop-up window, such that this window is displayed by the display screen of the piece of external equipment 13. The pop-up window may indicate, for example, the name of the future programme having been identified as being of interest, or even its time of broadcast or even the time until broadcast (in other words the time remaining before the time of broadcast). This visual alarm has the advantage of being more discreet than an audible alarm. The alert phase is then terminated (the end of the alert phase is represented in FIG. 4 by the point 3_12).

In step 3_6, the processing unit 14 commands the emission of an alarm by the user interface. Thus, in the current case, it is the decoder 11 which emits an alarm in a form perceptible by a user, without having to pass via the intermediary of the piece of external equipment 13. This is advantageous for several reasons. If the piece of external equipment 13 is switched off, then switching on of the piece of external equipment 13 is avoided. If the piece of external equipment 13 is switched on, then it is possible that a user is using this piece of external equipment 13 (for playing a video game or watching a DVD, for example). An alarm transmitted by the decoder 11 to the piece of external equipment 13 risks disturbing the viewing in progress by the user, and does so particularly if this alarm is visual in nature.

The alarm emitted in step 36 may be a visual alarm but is very preferably an audible alarm. This audible alarm is emitted by the speaker 111 of the decoder 11. An alarm of this type is more easily detectable by a user when a visual alarm which was displayed on the display screen of the decoder 11. In particular, a user located in a different room from the room where the decoder 11 is situated can hear the audible alarm, but could not see such a visual alarm.

The audible alarm preferably comprises a voice message generated by the processing unit 14 then rendered by the speaker 111 of the decoder 11. The voice message may indicate, for example, the name of the future programme having been identified as being of interest, or even its time of broadcast or even the time until broadcast (in other words the time remaining before the time of broadcast).

Once step 36 is performed, the alert phase ends (point 3_12).

An embodiment of the alert phase will now be detailed, comprising optional steps which are represented by dotted lines in FIG. 4. These optional steps can be implemented if the decoder 11 is provided with the previously described human presence sensor.

In this embodiment, the method moves from step 3_1 to step 3_3 if the decoder 11 is in wake-up mode (and not directly to step 32). At step 3_3, the decoder 11 checks whether a condition of human presence in the vicinity of the decoder 11 is fulfilled, by using the human presence sensor. The detector can check three alternative conditions at step 33. In a first alternative, the decoder 11 is limited to checking the existence of a presence of any human. In a second alternative, the decoder 11 checks whether a detected person corresponds to a previously enrolled user of the decoder 11; in this case, the human recognition module is used. In a third alternative, the decoder 11 checks whether a person detected in the vicinity is specifically the user of the decoder 11 for which the future programme has been identified as being of interest (in which case, the human recognition module is likewise used).

If the chosen condition of human presence is verified (block 3_4), then the method moves to previously described step 3_2. If no, the method moves to step 3_5.

In step 3_5, the processing unit 14 commands the emission of an audible alarm, as during step 3_6, by using the speaker 111 of the decoder 11. Then, the method moves to a step 3_10 which will be described below.

Furthermore, the method moves from step 3_1 to step 3_7 if the decoder 11 is in standby mode (and not directly to step 3_6). At step 37, the decoder 11 checks whether a condition of human presence in the vicinity of the decoder 11 is fulfilled, as during step 3_3. If the chosen human presence condition is verified (bloc 3_8) then the method moves to previously described step 3_6. If no, the method moves to step 3_9.

At step 3_9, the processing unit 14 commands recording of the programme. The programme can be recorded in the memory 15 of the decoder 11, in a removable memory 15 connected to the decoder 11 (such as an SD card or an external hard drive), or by a remote server. The recording can follow quota rules which can be controlled by the user via the user interface:
The size of the memory space 15 reserved for automatic recordings, with possibility of increasing or reducing this space. If reducing, the oldest recordings are deleted.
Activation of a circular buffer. If the dedicated memory space 15 is full, deleting the oldest recording in order to release the location.
Proposal to delete a recording at the end of its viewing.

In step 3_10, the processing unit 14 checks whether a user command has been received by the decoder 11 via the user interface in a predefined period t3 starting from the emission of the alarm generated at step 35, or at step 3_6. If yes, then the method ends (block 3_12). If no, the method moves to step 311.

At step 3_11, the processing unit 14 commands a recording of the programme in the memory 15, as in step 39.

The optional use of the human presence sensor during the alert phase is advantageous, because it avoids useless alarms in the absence of a user. In particular, this avoids audible alarms that might disturb the neighbourhood.

It should be noted that if the human presence sensor is used and if this sensor detects that an enrolled user is in the vicinity of the decoder 11, then the alarms emitted during the alert phase can be customised for this user (equally for both visual alarms and audible alarms). In a particular case, it may be that the programme identified during the search phase is a programme of interest for a first enrolled user, and that a second user different from the first user is detected in the vicinity of the decoder 11. A visual or audible alarm emitted in such a situation may therefore comprise a message indicating not only that a programme of interest will be broadcast shortly, but also indicate the user for who the message is intended (the first user in the preceding example).

Embodiments other than those presented in the description above can be envisaged.

It is expected that the decoder 11 and the method that it implements are applicable to audio/video media programmes, but also applicable to programmes without video (for example radio programmes) and programmes without audio.

Furthermore, the decoder as illustrated in FIG. 1 comprises at least one output intended to transmit data in view to their restitution by a piece of external equipment 13. This is not compulsory: the decoder 11 could alternatively play a programme directly via its user interface without using a piece of external equipment.

1. A method implemented by a media decoder, comprising:
identifying a future programme playable via the decoder and constituting a programme of interest for a user of the decoder,
comparing a time until broadcast of the programme of interest and a predefined threshold;
causing an emission of an alarm signal perceptible by a person, provided that the time until broadcast is less than the predefined threshold,
causing a recording of the programme of interest, the recording being implemented provided no user action on the decoder has been detected in a predefined period starting from the emission of the alarm signal.

2. The method according to claim 1, wherein the alarm signal is emitted provided that a person has been detected by a sensor of the decoder.

3. The method according to claim 2, wherein the alarm signal is emitted provided that the person detected is recognised by the decoder as a user of the decoder having been previously enrolled.

4. The method according to claim 2, wherein the alarm signal is emitted provided that the person detected is recognised by the decoder as a user of the decoder for which the programme is of interest.

5. The method according to claim 1, wherein the alarm signal is emitted by the decoder when the decoder is in standby mode.

6. The method according to claim 1, wherein the alarm signal is an audible signal.

7. The method according to claim 1, wherein the alarm signal is emitted by a piece of external equipment controlled by the decoder when the decoder is in wake-up mode.

8. The method according to claim 1, wherein the alarm signal is a visual signal.

9. The method according to claim 1, wherein the alarm signal comprises a message indicating the programme of interest.

10. The method according to claim 1, wherein identifying the future programme is triggered when at least one of the following events occurs:
a sensor of the decoder detects a person,
the decoder receives a list of future programmes playable via the decoder,
a predefined period since a preceding implementation of the comparison has elapsed.

11. The method according to claim 1, wherein the future programme is identified as a programme of interest for the user of the decoder only if the following conditions are fulfilled:
N past programmes having an identifier in common with the future programme have been played via the decoder,
N is greater than or equal to a predefined threshold.

12. A computer program product comprising program code instructions for causing an execution of the method according to claim 1, when this program is executed by a media decoder.

13. A non-transitory computer-readable medium comprising code instructions for causing a computer to perform the method according to claim 1.

14. A media decoder comprising:
a user interface,
at least one processor configured to:
identify a future programme playable via the decoder and constituting a programme of interest for a user of the decoder,
compare a time until broadcast of the programme of interest and a predefined threshold;
cause the user interface to transmit an alarm signal perceptible by a person, provided that the time until broadcast is less than the predefined threshold,
cause a recording of the programme of interest, the recording being implemented provided no user action on the decoder has been detected in a predefined period starting from the transmission of the alarm signal.

15. The media decoder according to claim 14, further comprising a sensor, wherein the alarm is emitted provided that a person has been detected by the sensor.

16. The media decoder according to claim 15, further comprising a module for recognising persons, wherein the alarm is emitted provided that a person detected by the sensor is recognised by the recognition module as a previously enrolled user of the decoder.
